(19) United States
(12) Patent Application Publication
(10) Pub. No.: US 2023/0267851 A1
(43) Pub. Date: Aug. 24, 2023

(54) SYSTEM AND METHOD FOR HYPER-PERSONALIZING DIGITAL GUIDANCE CONTENT

(71) Applicant: Whatfix Private Limited, Bangalore (IN)

(72) Inventors: Abhishek SANGHAI, Bengalaru (IN); Gourav H. DHELARIA, Bangalore (IN); Raj GANESH, Bengalaru (IN); Samvit MAJUMDAR, Bengalaru (IN); Maruthi Priya Kanyaka Vara Kumar NAMBURU, Bengalaru (IN)

(21) Appl. No.: 18/305,293

(22) Filed: Apr. 21, 2023

Related U.S. Application Data
(63) Continuation-in-part of application No. 17/643,683, filed on Dec. 10, 2021, now Pat. No. 11,669,353.

(51) Int. Cl. G09B 19/00

(52) U.S. Cl. CPC G09B 19/0053

(57) ABSTRACT

Provided herein are systems and methods for hyper-personalizing digital guidance for improved user adoption of an underlying computer application. In one exemplary implementation, a method includes identifying an underlying application, gathering usage data at a user level for n days, choosing at least two methods from the group consisting of sequence analysis, top popular analysis, repeat usage analysis, similar users analysis and popular analysis, combining results from the at least two chosen methods, and recommending content to a recommendation user based upon the combined results.

### CLAIM OF PRIORITY

This application is a continuation-in-part of U.S. patent application Ser. No. 17/643,683, filed Dec. 10, 2021, which is herein incorporated by reference in its entirety for all purposes.

### INCORPORATION BY REFERENCE

All publications and patent applications mentioned in this specification are incorporated herein by reference in their entirety to the same extent as if each individual publication or patent application was specifically and individually indicated to be incorporated by reference.

### BACKGROUND

There are many ways for end users to learn how to use a particular software application. Increasingly, many methods take the form of digital guidance, such as a Help Section built into the software application or links to online help content. Examples of online help or learning content include knowledge bases, answers to Frequently Asked Questions (FAQs), tutorials, videos, PDF documents, etc. “Walkthroughs” may be provided in either scenario, wherein the user is walked through a particular task or process step by step in the actual software application.

All of the digital guidance content may be provided to a user in one place, organized with a table of contents and or an index, and it may be searchable using keywords. Still, it may be overwhelming to a user to be provided with so much content at once. It is desirable to only provide a limited amount of digital guidance content to a user at any one time, focused on what they may currently need help with and not showing them content that is not currently relevant to what they are doing. Accordingly, a limited number of hyperlinks or other pathways to relevant content may be provided in various sections or segments of the software, and these links may change depending on the task being performed by the end user and or their location in the software application.

Currently when the users open self-help, all the users see the same set of contents as designed by the content creators. But the needs of individual users vary and hence, they have to spend time seeking out the particular content they need.

What is needed and is not provided by the prior art are improved systems and methods for providing digital guidance content, while reducing the burden being placed on the creators of the content. The innovations described herein solve these unmet needs and provide additional advantages.

### SUMMARY OF THE DISCLOSURE

According to aspects of the present disclosure, methods of personalizing digital guidance for use in an underlying computer application are provided. In some embodiments, a method includes the steps of identifying an underlying application in which it is desired to provide personalized guidance content, and identifying different pages of the underlying application from which usage data will be gathered. In these embodiments, the method further includes gathering usage data of the underlying application at a user level for n days. A user behavior matrix is then created from the gathered data with one axis of the matrix representing users of the underlying application and another axis of the matrix representing the different pages of the underlying application. The values in the matrix can represent a predetermined measure of each of the users' behavior on the different pages. Using the behavior matrix, a user similarity calculation can be performed for each pair of the users to obtain a similarity number for each of the pairs of users. The method further includes tabulating a consumption count for each of the users and a particular piece of digital guidance content each user has consumed. Each of the consumption counts reflects a number of times a particular user has consumed the particular content. Using the user similarity numbers and the consumption counts, a series of score calculations may be performed for a recommendation user, wherein each of the score calculations is a product of one of the consumption counts and an associated one of the similarity numbers. An intermediate score may be calculated for each of the pieces of content from the tabulating step, wherein each of the intermediate scores is calculated by summing the series of score calculations for each of the pieces of content. A number of users who clicked on each of the pieces of content is counted to obtain a click user count for each piece of content. A final score may be obtained for each of the pieces of content by dividing its intermediate score by its click user count. A ranking order of the content for the recommendation user can then be decided upon based on the final scores placed in descending order. The method includes recommending at least a highest ranked piece of content from the ranking step to the recommendation user.

In some embodiments, the gathering usage data step comprises recording a number of visits made by each of the users on the underlying application and or recording an amount of time each of the users spends on each of the different pages of the underlying application. The parameters determining values of the user behavior matrix may act as a hyperparameter In some embodiments, the values of the user behavior matrix comprise a sum of time spent by each of the users across visits on each of the different pages and or an average amount of time spent by the users per visit on the different pages.

In some embodiments, the method further includes a step of standardizing the values of the user behavior matrix. This step of standardizing the values may include rescaling the values to have a mean of 0 and a standard deviation of 1. In some embodiments, the method further includes a step of normalizing the values of the user behavior matrix. This step of normalizing the values may include rescaling the values so that they all fall into a range of 0 to 1.

In some embodiments, the user similarity calculations are based on one or more distance metrics selected from a group consisting of Correlation, Euclidean Distance, Manhattan Distance, Minkowski Distance and Hamming Distance. In some embodiments, the user similarity calculations act as a hyperparameter. In some embodiments, the pieces of content comprise walkthroughs. In some embodiments, all of the users who have consumed at least one of the pieces of content during the n days are used in the user similarity calculations. In some embodiments, some of the users who have consumed at least one of the pieces of content during the n days but have a low similarity number are not used in the tabulating and subsequent steps. In some embodiments, a quantity of the users who have a high similarity number and are used in the tabulating and subsequent steps is used as a hyperparameter.

According to aspects of the present disclosure, a non-transitory computer readable medium is provided having instructions stored thereon for personalizing digital guidance for use in an underlying computer application. The instructions are executable by a processor to cause a computer to perform some or all of the previously described method steps.

### BRIEF DESCRIPTION OF THE DRAWINGS

The novel features of the disclosure are set forth with particularity in the claims that follow. A better understanding of the features and advantages of the present disclosure will be obtained by reference to the following detailed description that sets forth illustrative embodiments, in which the principles of the disclosure are utilized, and the accompanying drawings of which:

FIG. 1 is a diagram showing an example of a digital guidance platform configuration for providing digital guidance in an underlying computer application.

FIG. 2 is a diagram showing exemplary configurations of how the digital guidance platform of FIG. 1 interfaces with an underlying computer application.

FIGS. 3A-3I are a series of partial screenshots showing exemplary functionality of a content authoring module/editor.

FIGS. 4A and 4B are screenshots showing examples of different lists of walkthroughs that are displayed by a content playback module depending on the location of an end user in an underlying software application.

FIGS. 5A-5I are a series of partial screenshots showing examples of types of segmentation criteria.

FIG. 6 is a table showing a user behavior matrix.

FIG. 7 is a table showing a correlation calculation for one pair of users.

FIG. 8 is a table showing a similarity number calculated for each click user relative to a recommendation user.

FIG. 9 is a table showing a score calculated for each combination of Click User ID and Content ID relative to a Recommendation User ID.

FIG. 10 is a table showing a Final Score and Rank calculated for each Content ID relative to a Recommendation User ID.

FIG. 11 is a flow chart summarizing steps of an exemplary digital guidance content personalization method.

FIGS. 12-13 are tables illustrating an exemplary Sequence Analysis portion of a second exemplary embodiment of a system for personalizing digital guidance content.

FIGS. 14-15 are tables illustrating an exemplary Top Popular Analysis portion of the second embodiment.

FIGS. 16-18 are tables illustrating an exemplary Repeat Usage Analysis portion of the second embodiment.

FIGS. 19-32 are tables illustrating an exemplary Similar Users Analysis portion of the second embodiment.

FIG. 33 is a table illustrating an exemplary Popular Analysis portion of the second embodiment.

### DETAILED DESCRIPTION

Described herein are apparatuses (e.g., systems, computing device readable media, devices, etc.) and methods for an improved digital guidance platform. The innovative platform changes the way application support and learning content is consumed. In some embodiments, this is accomplished by providing contextual and interactive walkthroughs inside software applications at the time a task is being performed (i.e. providing real-time guidance to users.) Examples of software applications that the platform may be used with include Salesforce®, Oracle CRM®, Microsoft Dynamics®, Success Factors®, SharePoint® and other applications. In some embodiments, the innovative platform may take the form of a simple web browser extension. Developers of a software application may use the extension to provide guided navigation to users of the software application so that the users can quickly learn how to use the application. The users' training and or support experience can be enhanced with walkthroughs, smart pop-ups and tool-tips provided by the platform. These platform tools may be configured to show up based on a particular user's role and current location in the software application. The innovative platform may be used with enterprise application software (such as the software applications mentioned above), custom application software (such as created by an IT department for a company's internal use), and end user software. Depending on the application, the innovative platform may be the only training and support program for the application, or it may be used in conjunction with a training and support program native to the application.

In some embodiments, the innovative platform supports an end user through their entire life cycle with a software application. This may include new user onboarding, continuous training, self-serve contextual support, assistance with data field validation, and application change management. The platform technology may include omni-channel integrations (such as integrating with knowledge systems, bases and repositories), workflow automation, in-place answers, workflow analytics, and content authoring.

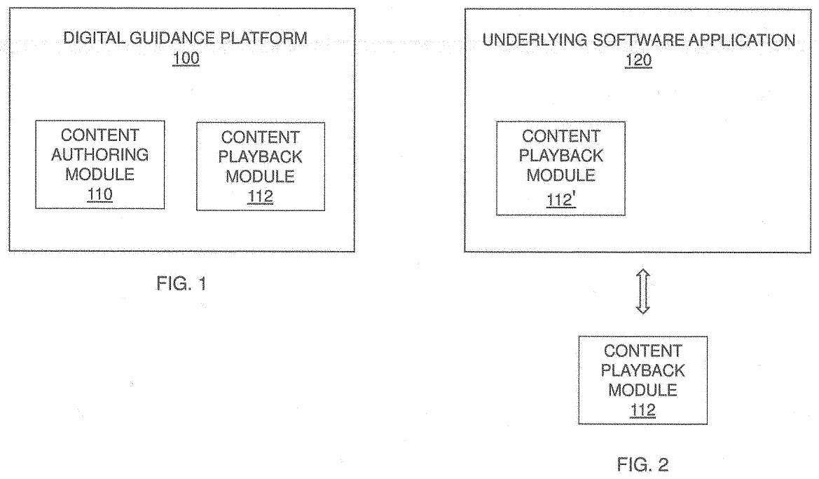

Referring to FIG. 1, an exemplary digital guidance platform 100 is depicted. It may include a content authoring module 110 (also referred to as an editor) and a content playback module 112, as shown. In this exemplary embodiment, the content authoring module 110 allows a content author to create digital guidance for end users of an underlying software application. Once this content is created and saved, it may be accessed or “played back” using the content playback module 112. In some implementations, the content authoring module 110 and the content playback module 112 are combined and provided to a content author in a single software package. In use, the software package may reside on a content author's computer, and or may reside on a server in “the cloud” and be offered as Software as a Service (SaaS.) In other implementations, content authoring module 110 and a content playback module 112 may be separately deployed. For example, one of the modules may take the form of a simple web browser extension as previously mentioned, and the other module may be downloaded to a content author's computer.

Referring to FIG. 2, exemplary content playback configurations are depicted. In some implementations, content playback module 112 is a standalone system that is accessed by an end user from within an underlying software application 120. For example, an underlying software application 120, such as Salesforce®, may be provided with links to access content playback module 112, which is located on a server in the cloud. In some implementations, content playback module 112′ may be integrated within the underlying software application 112′. In either of these exemplary configurations, the end user is able to access the digital guidance content from content playback module 112 or 112′ while using a feature of underlying software application 120 with which the content is associated. In some implementations, both an integrated content playback module 112′ and an external module 112 are available to the end user.

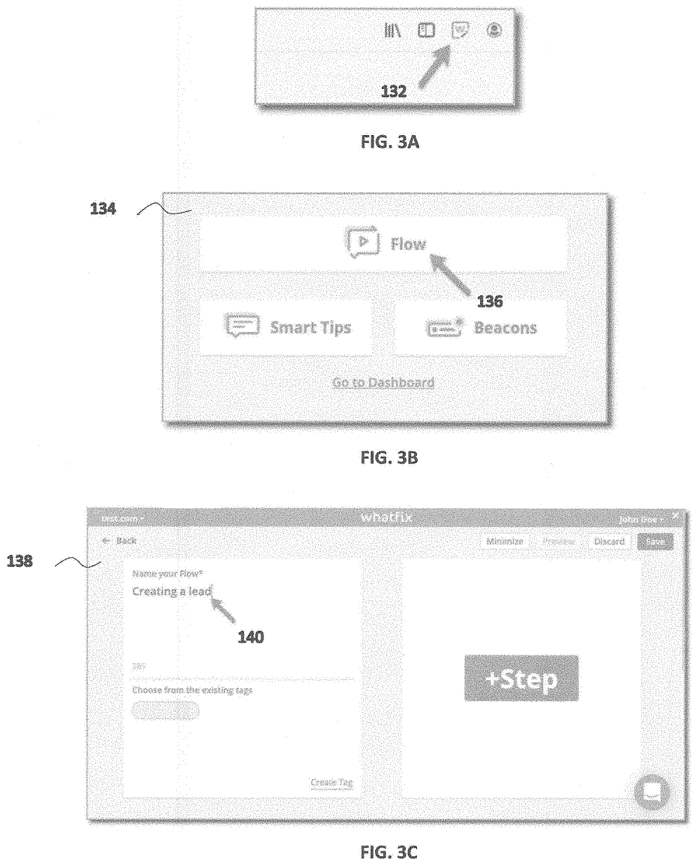

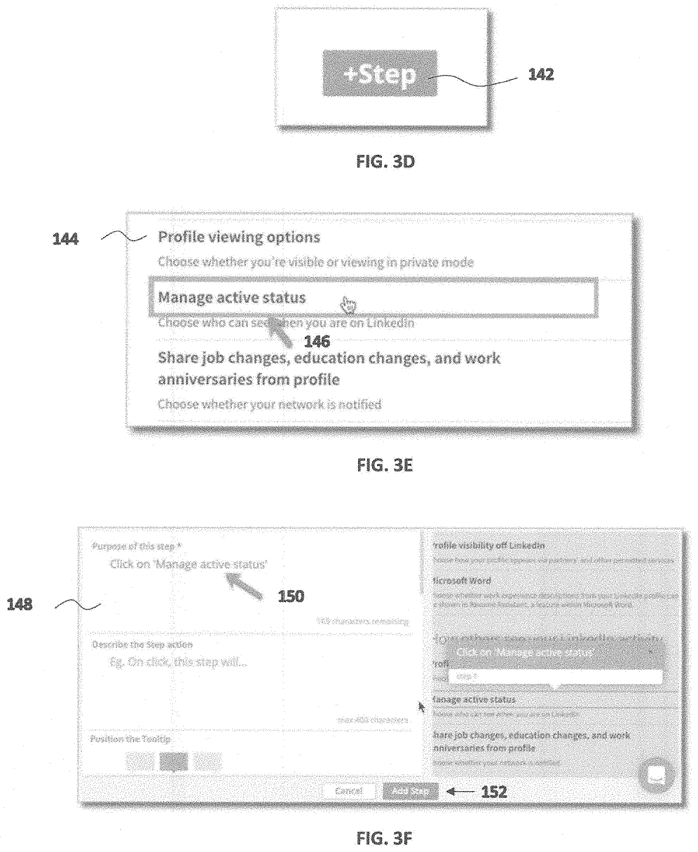

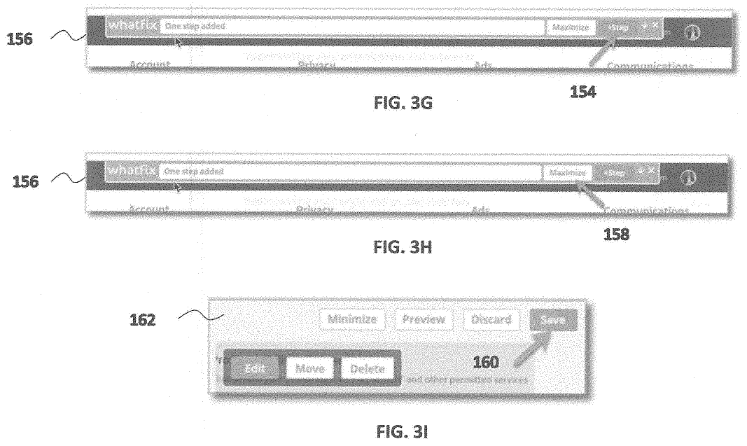

Referring to FIGS. 3A-3I, exemplary functionality of content authoring module/editor 110 will be described in relation to the exemplary partial screenshots in the figures. In this exemplary embodiment, the patent applicant's company name “whatfix” is used as the name of digital guidance platform 100. The exemplary functionality includes the ability to create a “walkthrough”, which will walk an end user of underlying software application 120 through each sequential step of a particular task in application 120 when the walkthrough is played back. In some implementations, the walkthrough can proceed either one step at a time, waiting at the end of each step for the end user to advance the walkthrough to the next step. Alternatively, the walkthrough can proceed automatically, running through all of the steps without stopping (unless paused by the user.) Additionally, the walkthrough can provide the end result of the task that the walkthrough is teaching. For example, a walkthrough can show an end user each step needed to determine the number of open sales leads that have not been contacted, and at the end of the walkthrough the actual number is provided to the end user. Referring first to FIG. 3A, the creation of a walkthrough begins by the author logging in to the underlying application where the author wants to create content, and then launching the previously described content authoring module/editor 110 by clicking icon 132.

Once the editor launches, it displays window 134 as shown in FIG. 3B. Window 134 includes three buttons labeled Flow, Smart Tips and Beacons. The Flow button is for creating walkthroughs, the Smart Tips button is for creating content associated with data field validation, and the Beacons button is for creating content associated with software application change management. In this example the author clicks the Flow button 136.

Clicking Flow button 136 opens window 138, as shown in FIG. 3C. Here the author can name the Flow or walkthrough as they want it to be displayed to an end user. In this example, the Flow is named “Creating a lead”, as shown by arrow 140.

The author then clicks the +Step button 142, as shown in FIG. 3D. In some embodiments, the pointer icon changes (such as from an arrow to a hand), as shown in screen 144 of FIG. 3E, to indicate that the editor is waiting for the author to select a step of the sequence that the end user is to be guided through. The author then clicks the desired element on the page of the underlying software application that the end user will need to select. In this example, the end user will be guided to select the Manage Active Status button 146 on screen 144 during playback of the walkthrough, so the Flow author clicks button 146 at this time.

After the Flow author clicks the desired element 146, the editor module displays screen 148 as shown in FIG. 3F with automatically generated action text 150 describing the particular step. The Flow author may then review, edit and or add text or other information associated with the step. The author may also select other parameters regarding how this step of the walkthrough will be played back, such as the position of the Tooltip on the screen, or accept some or all of the default settings. Once the parameters of this step are in order, the author then clicks the Add Step button 152.

To capture the next step in the sequence, the Flow author then navigates to where in the underlying software application the author wants to start the next step. The author then clicks the +Step button 154 in the editor toolbar 156, as shown in FIG. 3G. The pointer icon again changes to indicate that the editor is waiting for the author to select another step of the sequence, as previously described in reference to FIG. 3E. The author then repeats the intervening actions described above for each step that is to be added to the Flow sequence. When all the steps have been captured, the author clicks the Maximize button 158 on the editor toolbar 156, as shown in FIG. 3H, and then clicks the Save button 160 after window 162 opens, as shown in FIG. 3I.

Before various walkthroughs are made available to end users of the underlying software application, segmentation or mapping may be used to associate each walkthrough with a particular page or part of the underlying software. Segmentation helps content authors display only walkthroughs that are relevant to end users when they are on a particular page. Segmentation, as the name implies, provides a way of targeting walkthroughs to specific users on “widgets” like Self-help and Task List on previously described content playback module 112. Segments can be defined through various conditions and rules. In some embodiments, a segment can be built to filter walkthroughs as per user login, the contents of a Uniform Resource Locator (URL), elements on the screen, and/or a mix of other criteria. For example, segments may be used to display walkthroughs based on a particular group of users' logins, a current tab an end user is on, visual elements on pages of the underlying software and/or other variable(s) defined by the walkthrough author.

In one embodiment, a page of the underlying software application may have two different tabs, for example: Leads and Contacts. Using segments, different walkthroughs can be displayed depending on which tab the end user navigates to. Rather than seeing a long list of help content, the end user only sees contextual content that is relevant to the particular page and tab currently being used. FIG. 4A shows an example of a list of walkthroughs 170 that is displayed by content playback module 112 when the end user has navigated to the Leads tab 172 of an underlying Salesforce application and clicked on Self Help. FIG. 4B shows an example of a different list of walkthroughs 174 that is displayed by module 112 when the end user has navigated to the Contacts tab 176.

Segments can be created through a simple selection of walkthroughs and visibility rules provided in the editor module 110. To segment walkthroughs, an author can manually select all the necessary flows/walkthroughs to display on a particular page of the application. Segmentation can be set up based on tags as well. Tags can be as simple as a user group or the page/module name. Segmentation of flows can be set up through single or multiple tags. In some embodiments, the editor module 110 can perform segmentation on the basis of visual elements found in the application. The editor can segment flows based on visual elements present or absent on various pages of the underlying application.

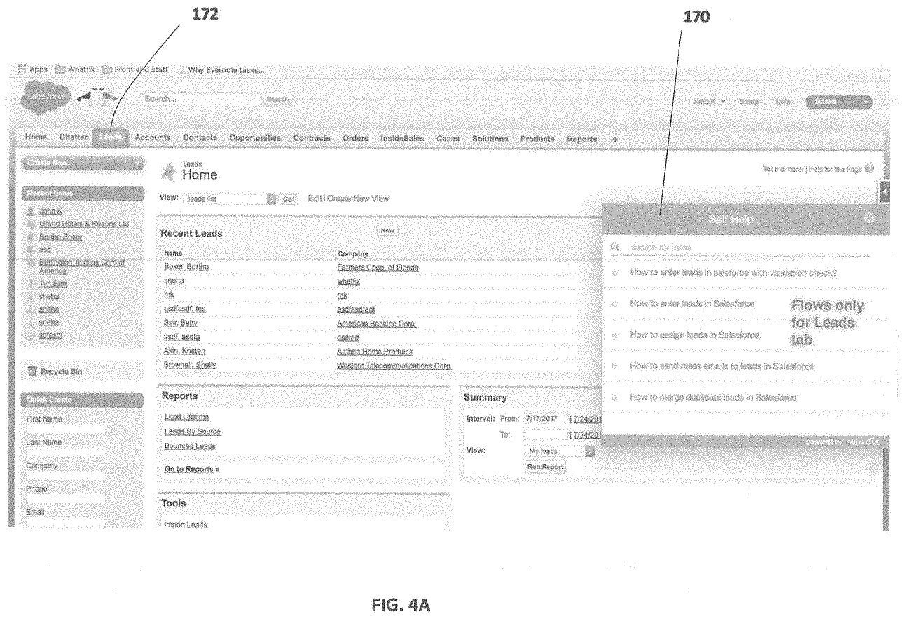

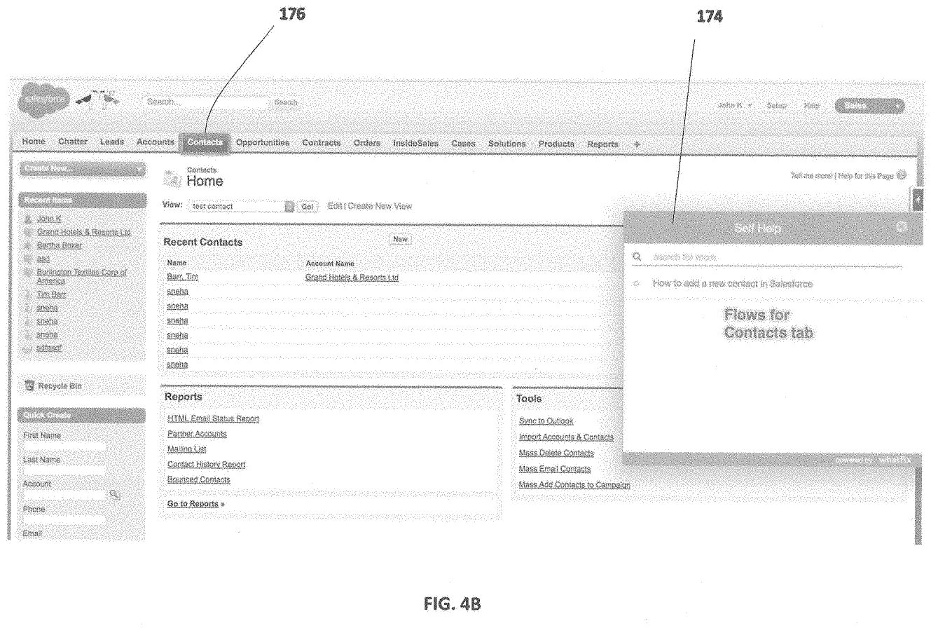

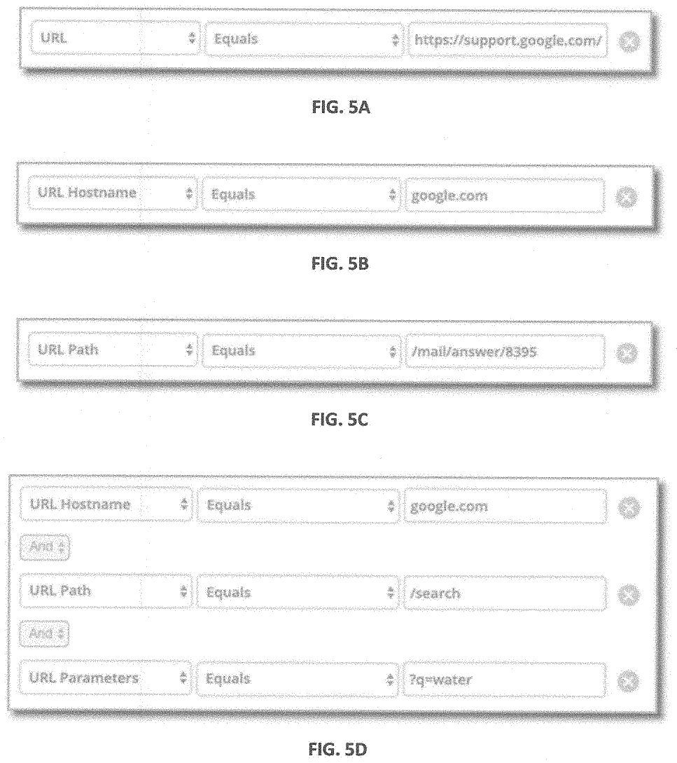

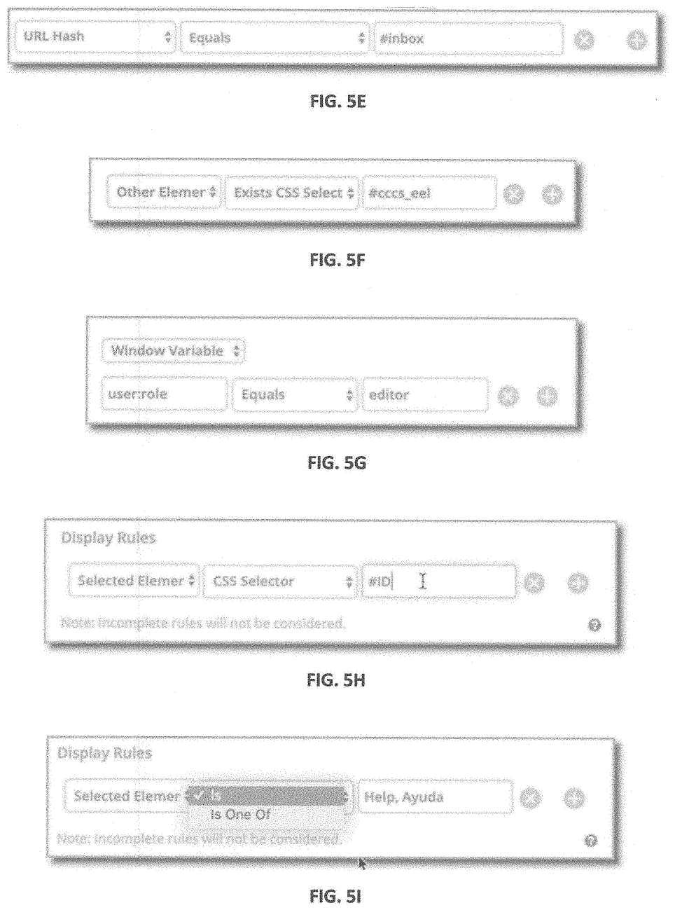

Referring to FIGS. 5A-5I, specific examples of types of segmentation criteria that may be used are provided.

Referring to FIG. 5A, a Uniform Resource Locator (URL) may be used to segment flows. In some embodiments, any part of the URL may be specified as a visibility rule. For example, the URL Hostname, path, parameter, etc. may be specified using this criterion.

Referring to FIG. 5B, a URL Hostname may be used to segment flows. In some implementations, a content author may want to uniquely identify a page using the domain name and can use this condition. The URL Hostname is the first part of any URL. For example, if the author wished to display the tip only if the end user is on google.com, she can add a condition as shown in the screenshot of FIG. 5B.

Referring to FIG. 5C, a URL Path may be used to segment flows. The website path name is what is listed between a domain name and the parameters or hashes. For example, if the website URL is //support.google.com/mail/answer/8395?hl=en&ref_topic=3394219, then the pathname is /mail/answer/8395. This condition may be specified as shown in FIG. 5C.

Referring to FIG. 5D, a URL Parameter may be used to segment flows. If an author wishes to identify a web page using the parameters on the URL, this condition may be used. For example, if a tip is to be shown to a user only when the search phrase has “water” in Google, this can be set up as shown in FIG. 5D. In this example, three conditions need to be met: 1) the page must be google.com (URL Hostname); 2) the pathname is /search (URL Path); and 3) the query parameter is ?q=water.

Referring to FIG. 5E, a URL Hash may be used to segment flows. In particular, a page may be identified using the hash value of the URL using this condition. Hashes are usually present in Single page applications made using AngularJs or ReactJs. Typically, there are no page refreshes but only Hash changes.

Referring to FIG. 5F, Other Elements may be used to segment flows. For example, if a content author wants to identify a page based on the presence of a particular element (other than the one selected by the author for the flow) on the web page, this condition can be used. In some embodiments, the values passed to this condition are Cascading Style Sheets (CSS) selectors, such as #ID, .class or Jquery. Cascading Style Sheets is a stylesheet language used to describe the presentation of a document written in HTML or XML. CSS describes how elements should be rendered on screen or on other media. Note that in some implementations, use of this condition to segment flows can slow down the underlying application. Further information on the use of CSS selectors may be found on the internet, such as at https://developer.mozilla.org/en-US/docs/Web/CSS/CSS_Selectors.

Referring to FIG. 5G, a Window Variable may be used to segment flows. In some implementations, a value of a particular JavaScript global variable is used to identify conditions for showing tooltips. For example, an option to check “user.role=‘admin’” may be provided to set this condition. This option may also be to perform comparisons, such as using the following criteria: Greater than; Less than; Date Greater than; or Date Less than.

Referring to FIG. 5H, an Element CSS Selector/JQuery may be used to segment flows. In some implementations, the application uses unique IDs for some elements on the page. This option may be used when the element is selected from a list of options. For example, a drop-down menu. This lets an author provide their own CSS selector identifier for the element. Sample values include: #ID_ELEMENT; CLASSNAME; input[title=“Search”]; and $(“#ID”).

Referring to FIG. 5I, an Element Text may be used to segment flows. In some implementations, this is the text that is displayed on the Element selector that is described above in reference to FIG. 5H. If an application supports multiple languages, the option “is one of” may be chosen and the name added with a comma (,) as a delimiter.

The exemplary segmentation criteria described above with reference to FIGS. 5A-5I may be used to manually segment various flows/walkthroughs and other content. According to aspects of the disclosure, editor module 110 may also be configured to automatically segment the content. In some embodiments, the content is automatically segmented as it is created, with no additional steps required by the content author. This may be referred to as “intelligent segmentation” (IS). In some embodiments, intelligent segmentation eliminates the need to create multiple segments (manually) to display relevant content contextually to different audiences on an underlying application. For example, if an underlying application has five pages and two user roles, traditionally ten segments would need to be created to ensure that each kind of user sees only the relevant topics on each of the five pages. But when intelligent segmentation is enabled and content is being created, editor module 110 can automatically determine which content is to be shown on which page. In some embodiment, editor module 110 can do this based on where the walkthrough was created and certain other pre-defined criterion. The content author need not do any additional configuration as more content is created.

Intelligent segmentation can also ensure that if an end user is not on the first screen of a walkthrough, playback of the walkthrough starts from the most relevant page that the user is on. For example, the walkthrough that the user is launching may have 10 steps. If the user is already in step 3 on the application and then decides to launch the walkthrough, IS ensures that the walkthrough starts from step 4 and not from the earlier steps that the user has already completed.

Currently when the users open self-help, all the users see the same set of contents as designed by the content creators. But the needs of individual users vary and hence, they must spend time seeking out the particular content they need. Instead, the contents can be personalized for every user based on a recommendation engine as described herein, so that users find the content they need upfront when they open self-help. Users also find self-help more useful and their engagement with self-help goes up. This results in self-help being used more often and not for longer period of time, thereby improving user engagement.

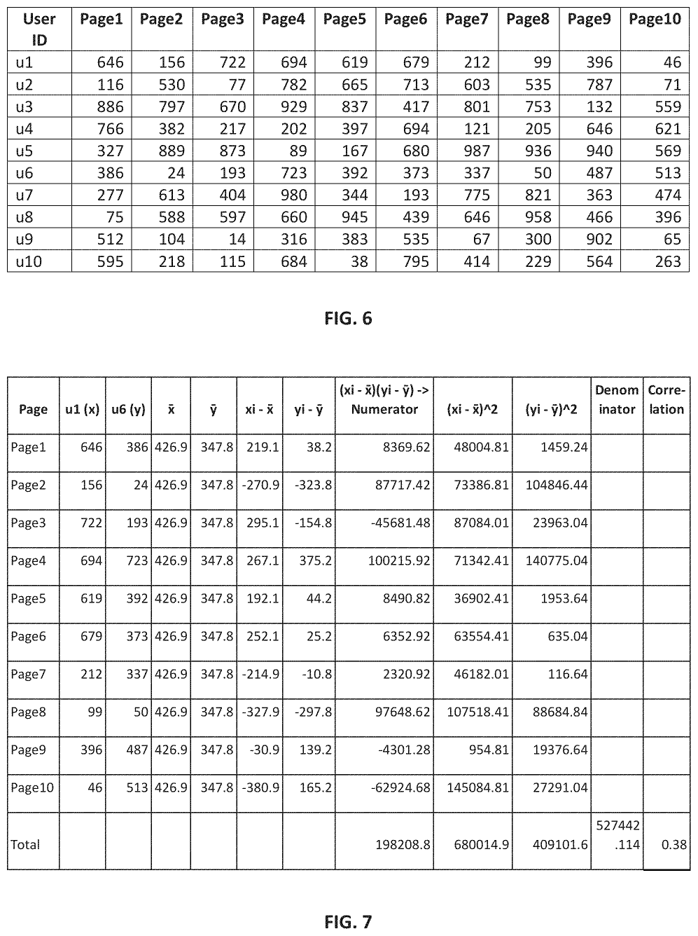

According to aspects of the present disclosure, systems and methods are provided for personalizing the previously described digital guidance content. Referring to FIGS. 6-11, a first exemplary embodiment of a system implemented according to aspects of the present disclosure will be described. This exemplary embodiment is premised on the hypothesis that users who behave similar to each other on an underlying application need a similar kind of help as they are aware/unaware of similar facets of the application.

Referring first to FIG. 6, an underlying application is first identified in which it is desired to provide personalized guidance content. Next, different pages of the underlying application are identified from which usage data will be gathered. In this exemplary embodiment, ten pages are identified, labeled Page 1 through Page 10. Usage data of the underlying application is gathered at the user level for n days, with n being a hyperparameter. In this exemplary embodiment, there are ten users identified as u1 through u10. The number of visits made by each user on the application is recorded. Also recorded is the amount of time each user spends on each of the different pages of the underlying application. From this, a user behavior matrix can be created, with row indexes being the user IDs and the columns being different pages of the application, as shown in FIG. 6. The values in this matrix can take different forms and can act as a hyperparameter. In this exemplary embodiment, the matrix values are the sum of time spent by each user across visits on each of the pages, with dummy values provided in FIG. 6 for ease of understanding. In alternative embodiments, the matrix values can be the average time spent per visit on these pages by the users. In some embodiments, the values of the matrix are standardized. For example, the values can be rescaled to have a mean of 0 and a standard deviation of 1 (unit variance). In other embodiments, the values of the matrix are normalized. For example, the values can be rescaled so that they all fall into a range of 0 to 1, or 0 to 1000. Each of the rows of this matrix can act as a vector that defines each user's behavior on the underlying application.

Using the values from the matrix of FIG. 6, user similarity between each pair of users can be calculated. The similarity may be calculated based on different distance metrics, such as:
Correlation
Euclidean Distance
Manhattan Distance
Minkowski Distance
Hamming Distance

In this exemplary embodiment, the following correlation formula is used:

$${r}_{xy} = \frac{\sum ( {x}_{i} - \overline{x} ) ( {y}_{i} - \overline{y} )}{\sqrt{\sum {( {x}_{i} - \overline{x} )}^{2} \sum {( {y}_{i} - \overline{y} )}^{2}}}$$

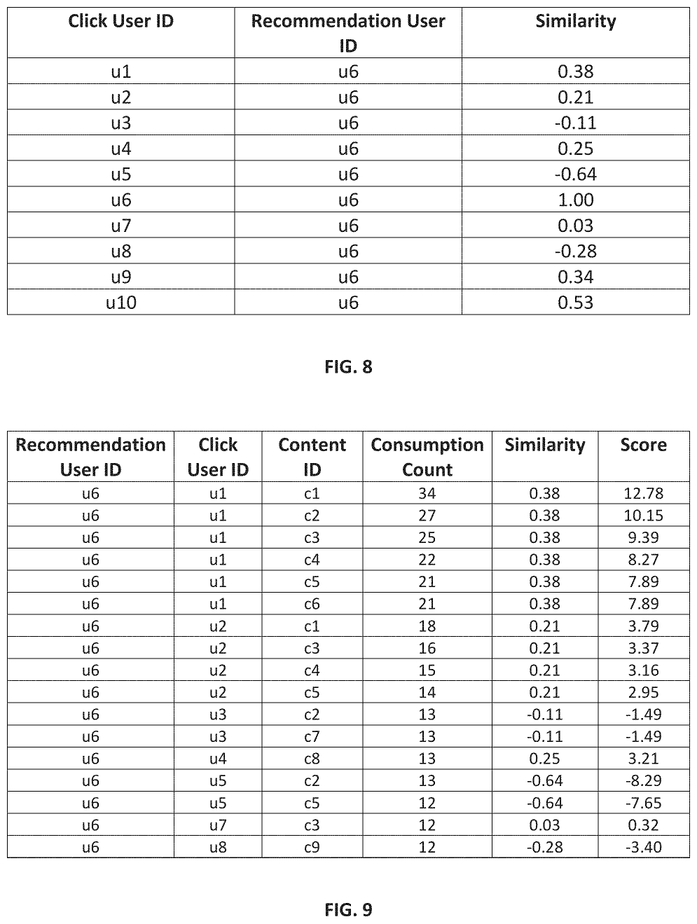

A sample correlation calculation is provided in FIG. 7, using the above formula and the values from FIG. 6, for just the pairing of u1 with u6. As shown, a correlation of 0.38 results between u1 and u6, which is recorded in the first line of the chart of FIG. 8. These similarity calculations can act as a hyperparameter. In some embodiments, all the users who have consumed at least one unit of content in a selected period of n days are considered for “click users”, while the users for whom the system is recommending content are termed “recommendation users.”

Referring to FIG. 9, in order to come up with recommendations for a user (for example, u6), the similarity of click users with u6 and the number of times a particular piece of content (i.e., Content IDs c1 through c9 in this example) was consumed by the click users can be considered. Only the pairings of user u6 with the other users are shown in this example. In some embodiments, each Content ID represents a separate “walkthrough” as previously described. A number of click users most similar to u6 may be chosen to proceed with the calculations. The number of most similar click users can also be a hyperparameter. In this example, the number of most similar click users is 8, with users u9 and u10 being dropped from further calculations. The Score column in FIG. 9 can be calculated as the product of the Consumption Count and the Similarity number for each pairing of Content ID and click user.

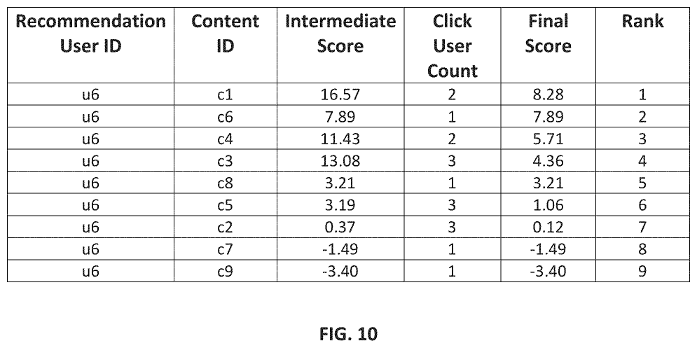

Referring now to FIG. 10, the Scores from FIG. 9 can be summed up for each Content ID to get the Intermediate Score, and the number of users who clicked on each piece of content can be counted, as shown. Next, the final score of each piece of content for every user may be obtained by dividing the Intermediate Score by the Click User Count. The ranking order can then be decided by the final score in descending order, as shown. The personalized help system can now recommend help content based on these rankings. In some embodiments, only the top result is provided to the underlying user. In other words, only the walkthrough or other content associated with Content ID c1 is provided to the user u6 when they are on a particular page of the underlying application. In some embodiments, only the top X pieces of content are provided, where X is 1, 2, 3 or more. For example, if X is predetermined to be 3, then the content associated with Content IDs c1, c6 and c4 would be shared with user u6 in this example. In some embodiments, only content above a certain Final Score may be shared. For example, if a Final Score limit of 7.5 is set, then the content associated with Content IDs c1 and c6 would be shared with user u6 in this example since only those pieces of content had a Final Score above 7.5. In some embodiments, all of the ranked content is provided to the underlying user in ranked order.

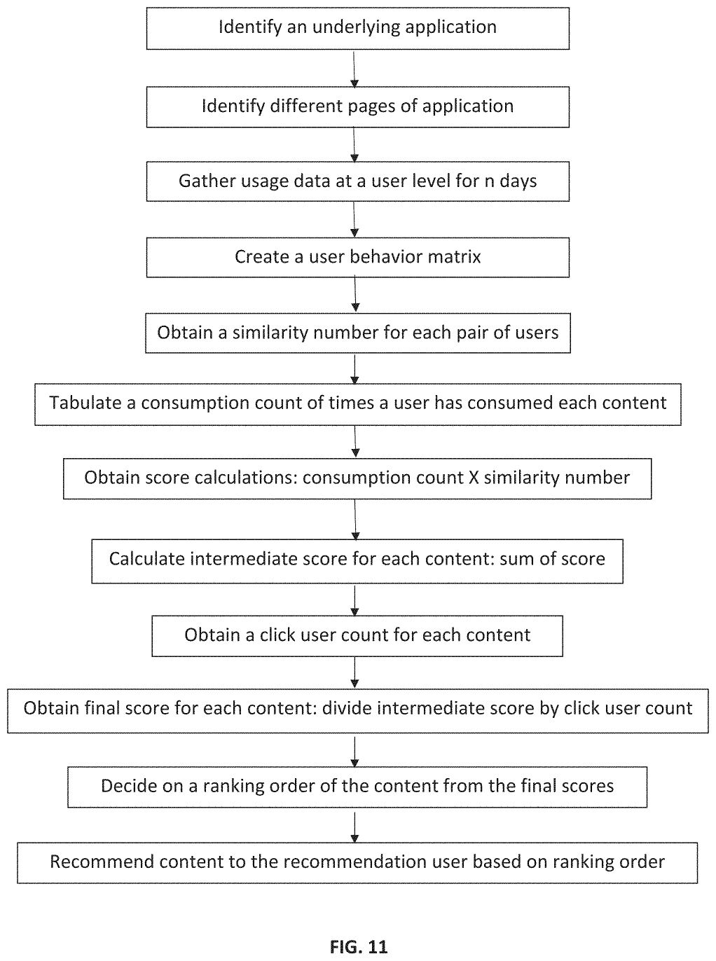

Referring to FIG. 11, a summary of the steps of the above exemplary personalization method is provided.

A hyperparameter is a configuration that is external to the model and whose value may not be able to be estimated from the data. Hence, these values may be used as an input to the model and decided through hit and trial methods. In some embodiments, in order to decide the final values of the hyperparameters, a grid search may be performed (e.g., recommendations may be generated for each set of options) on the historical data and the results may be checked against more recent data. In some embodiments, the process involves machine learning where the output is checked against actual usage to finalize the values of the hyperparameters.

When used in the Digital Adoption Platform category, the above-described user similarity matrix may be improved in some embodiments by considering one or more of the following factors to adjust the calculated content recommendations:
A user's role/job function information
Auto tags to help identify different pages of the application at different granularities
Seasonality/Cyclic behavior, as certain specific applications have seasonal/cyclic usages, such as Human Capital Management (HCM) tools
Number of days user has been using the application (i.e., maturity level of the user with respect to the application)
The User Actions/processes a particular user performs on the application

The above-described exemplary system is General Data Protection Regulation (GDPR) compliant, so minimal data may be used. No Personal Identifiable Information (PII) need be used in determining the recommendations.

“User buckets” may be created to capture the user data described above. The user buckets can be completely dynamic in nature. For example, they may be recreated every day based on the last n days of data. Also, the buckets may be created from the perspective of the user being recommended. For example, for user u6, the buckets can be {u1,u2,u6}, while for user u1, the buckets can be {u1,u3,u7}.

As previously mentioned, not all the click users need be used to decide the recommendations. Rather, a fewer number of most similar click users will often yield better content recommendations for a recommendation user.

In this exemplary embodiment, the recommendations are agnostic to underlying changes to the application as the system does look at the time spent on the page and not what the content of the page is.

Consideration of only the last n days keeps the recommendation relevant to the system and the user. This can ensure that past usage does not skew current recommendations. In some embodiments, the recommendations are updated every day.

A new user can instantly be provided with a recommendation after 1 day of being in the system. A separate bucket can be designed for new users to check their behavior.

Enterprise Customization requests can also be entertained, e.g., content creators' requests for ordering certain contents may also be taken care of. This allows those in the Digital Adoption Platform category to maintain a direct line of communication with their content creators.

Recommendations for a given user can be different for different pages of the underlying application, making the contents more relevant to a given page.

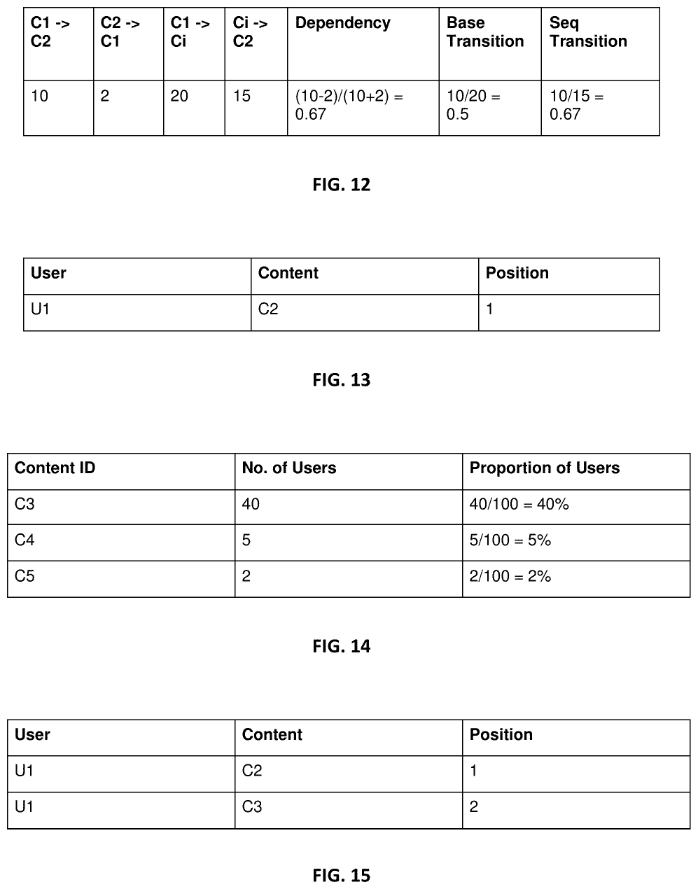

Referring to FIGS. 12-33, a second exemplary embodiment of a system for personalizing the previously described digital guidance content, implemented according to aspects of the present disclosure, will be described. Much like the first exemplary embodiment described above relative to FIGS. 6-11, this second exemplary embodiment is premised on the hypothesis that users who behave similar to each other on an underlying application need a similar kind of help as they are aware/unaware of similar facets of the application. Furthermore, this second exemplary embodiment is premised on the additional hypothesis that feedback from users on recommendations previously provided can further help provide hyper personalized content for the users.

At the beginning of a software application subscription, all users typically will see the same contents, as defined by the authors of the account. Through the inventive personalization algorithms disclosed herein, more relevant contents is typically shown to the user. In some embodiments, this includes:
1. Looking at the amount of time a user spends on different pages of the application;
2. Calculating similarity between users; and
3. Recommending contents used by similar users to a given user.

In continuation to this, and in particular in the second exemplary embodiment, parameters are used that look at multiple dimensions of usage of the application by the users and then decide the similarity of users. This can also be combined with other approaches of recommendation that together decide the final set of recommendations for the user. Each approach may be given a priority order. For example, if there are positions for 5 recommendations, in this second exemplary embodiment, “Sequence” takes Position 1, “Top Popular” takes Position 2, “Repeat Usage” takes Position 3, and “Similar Users” fill the remaining positions, as will be further described below. If there are not enough recommendations to fill all the positions, “Popular Approach” may fill up the remaining positions.

Additionally, indirect feedback from the users through their usage of a self-help widget may be used to reorder the recommendations. By using the above parameters, contents served to the user may be “hyper-personalized”.

The following summarizes what is meant by the terms used above:
1. Sequence—Identify Contents that are used one after the another in subsequent application visits. This may be identified at the application level, and sequences may be ranked per a calculated Dependency Score, as described below. One content may be chosen from this for each user if applicable to be recommended at Position 1.
2. Top Popular—Identify Contents that have been consumed by more than a predetermined number or percentage (e.g., 10%) of the users in self-help in a predetermined time period (e.g., the last 30 days). Out of these, the contents that have already been consumed by a particular user at least once in their lifetime may be removed. One content from this which is not part of the prior list may be obtained. In this exemplary second embodiment, this content will be recommended at position 1 or 2, depending on if the Sequence approach yielded a piece of content.
3. Repeat Usage—Identify Users that are highly likely to reuse contents and Contents that are highly likely to be reused by users. A combination of both may be used as Repeat Usage suggestions for users. In this exemplary second embodiment, this list will only contain contents that have been used by a user previously, and one content from this list which is not part of prior lists will be used. This content may be recommended at Position 1, 2 or 3, depending on if previous approaches yielded a piece of content.
4. Similar Users—Use Contents used by similar users to come up with recommendations. In this exemplary second embodiment, contents from this list which is not part of prior lists is used. This content may be used to fill up the remaining recommendation slots.
5. Popular—Any remaining spots may be filled with the most consumed contents.

Referring to FIGS. 12-33, a specific exemplary approach is provided which depicts how recommendations may be calculated for a specific user, U1.

### Sequence Analysis

Referring first to FIG. 12, the exemplary approach starts with a Sequence analysis, which identifies contents that have a high probability of being used one after the other in an account by users.

The exemplary Sequence analysis utilizes the following Parameters:

The parameters C1 and C2 represent specific content, while Ci represents a general piece of content. In this example, C1 is not the same as C2.

The parameter “seq_users” equals the number of users who used content C2 just after C1.

The parameter “reverse_seq_users” equals the number of users who used content C1 just after C2.

The parameter “N_base” equals the number of users who used any content after C1.

The Parameter “N_seq” equals the number of users who used any content before C2.

The exemplary Sequence analysis also utilizes the following Metrics:

The metric “Dependency” equals (seq_users−reverse_seq_users)/(seq_users+reverse_seq_users).

The metric “Base Transition” equals seq_users/N_base.

The metric “Seq Transition” equals seq_users/N_seq.

FIG. 12 is a table that depicts the numbers of users and corresponding Sequence calculations for a hypothetical case. Column 1 shows that in this hypothetical case, there are 10 users who used content C2 just after using content C1 (i.e., seq_users=10). Column 2 shows that in this case, there are 2 users who used content C1 just after using content C2 (i.e., reverse_seq_users=2). Column 3 shows that in this case, there are 20 users who used any content Ci after using content C1 (i.e., N_base=20). Column 4 shows that in this case, there are 15 users who used any content Ci before using content C2 (i.e., N_seq=15). Column 5 provides a Dependency calculation for this case: (seq_users−reverse_seq_users)/(seq_users+reverse_seq_users), yielding a result of 0.67. Column 6 provides a Base Transition calculation for this case: seq_users/N_base, yielding a result of 0.5. Column 7 provides a Seq Transition calculation for this case: seq_users/N_seq, yielding a result of 0.67.

In this exemplary Sequence analysis, Criteria may be set that content must meet in order to be recommended to a user. If one or more sequences meet all these Criteria, the top sequence that satisfies the Criteria is allowed to become part of the recommendations.

For the above hypothetical case, the following Sequence Criteria may be used:
Base_transition>=0.2, and
Seq_users>=10, and
Seq_transition>=0.2, and
Dependency>=0.5.

Various sequences in this example may be tested through a grid search (e.g., C1, C2, C3, . . . Cn by C1, C2, C3, . . . Cn, where n is the number of content available) and can vary for different accounts. As the sequence above (i.e., C1 & C2) satisfies all the Sequence Criteria, it may be used to provide a recommendation (i.e., C2) to the user. So, in this hypothetical case, if a user U1 used content C1 the previous day, then content C2 would be part of their recommendations for the current day, and it would be given Position 1, as shown in FIG. 13.

Referring now to FIG. 14, after a Sequence analysis such as that described above is performed, the exemplary approach proceeds to a Top Popular analysis. In some embodiments, a Top Popular analysis identifies a content only if it is used by more than a threshold proportion of users in the last 30 days. For the example below, it is assumed that the total number of users in an account who have consumed content from self-help in the past 30 days is 100.

The exemplary Top Popular analysis utilizes the following Parameters:
The parameters C3, C4 and C5 represent specific content.
The parameter ni equals the number of users who consumed content Ci.
The parameter N equals the number of users who consumed at least 1 content from self-help in the last 30 days.

The exemplary Top Popular analysis also utilizes the following Metric:
The metric “Threshold” equals ni/N.

### Top Popular Analysis

FIG. 14 provides a sample of which content was consumed by how many users in this example, and calculates the proportion of users (ni/N) that used each content.

In this exemplary Top Popular analysis, Criteria may be set that content must meet in order to be recommended to a user. If one or more pieces of content meet this Criteria, the top content that satisfies the Criteria is allowed to become part of the recommendations. For example, the Criteria may be Threshold>10%. The threshold may be tested through a grid search and can vary for different accounts. As shown in FIG. 14, content C3 meets the criteria and would therefore be part of recommendations for all users who have not used it before. In this example, content C3 would fill Position 2 for user U1, as shown in FIG. 15.

### Repeat Usage Analysis

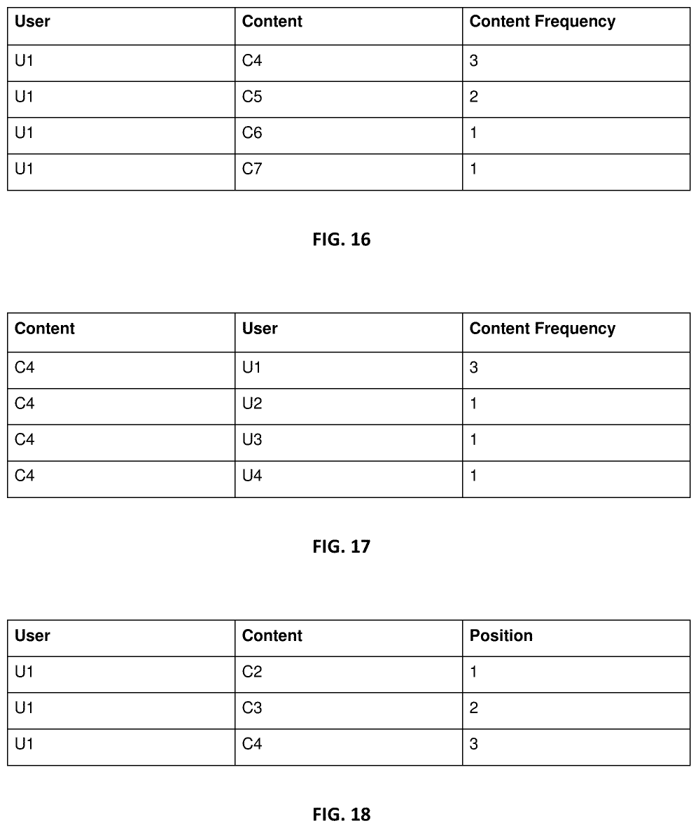

Referring now to FIGS. 16 and 17, after a Top Popular analysis such as that described above is performed, the exemplary approach proceeds to a Repeat Usage analysis. In some embodiments, a Repeat Usage analysis calculates an affinity of users to reuse contents frequently as well as an affinity of content to be used by users again and again. In some embodiments, a threshold can be put on both affinities. In some embodiments, if users who pass the user criteria have used a content that also passes the content criteria, then the content is considered to be recommended for the user.

The exemplary Repeat Usage analysis utilizes the following Parameters:

The parameter “Content Frequency” equals the number of different days on which a content is used by a particular user.

The parameter “User Frequency” equals the number of different days on which a user used the content.

The exemplary Repeat Usage analysis also utilizes the following Metrics:
User_repeatability=sum(Content Frequency)/count(Content)
Content_repeatability=sum(User Frequency)/count(User)

FIG. 16 depicts an example of how often a particular user U1 uses various content. From this, the metric User_Repeatability for user U1 may be calculated as (3+2+1+1)/4=1.75.

FIG. 17 depicts an example of how often a particular piece of content C4 is used by various users. From this, the metric Content_Repeatability for content C4 may be calculated as (3+1+1+1)/4=1.5.

In this exemplary Repeat Usage analysis, Criteria may be set that content must meet in order to be recommended to a user. If one or more content meets all these Criteria, the top content that satisfies the Criteria is allowed to become part of the recommendations.

For the above hypothetical case, the following Repeat Usage Criteria may be used:
User_Repeatability>=1.5, and
Content_Repeatability>=1.5

The numbers above may be tested through a grid search and can vary for different accounts. The example numbers shown in FIGS. 16 and 17 pass both criteria, as calculated above. Accordingly, user U1 would be recommended content C4. In this example, content C4 would fill Position 3 for user U1, as shown in FIG. 18.

### Similar Users Analysis

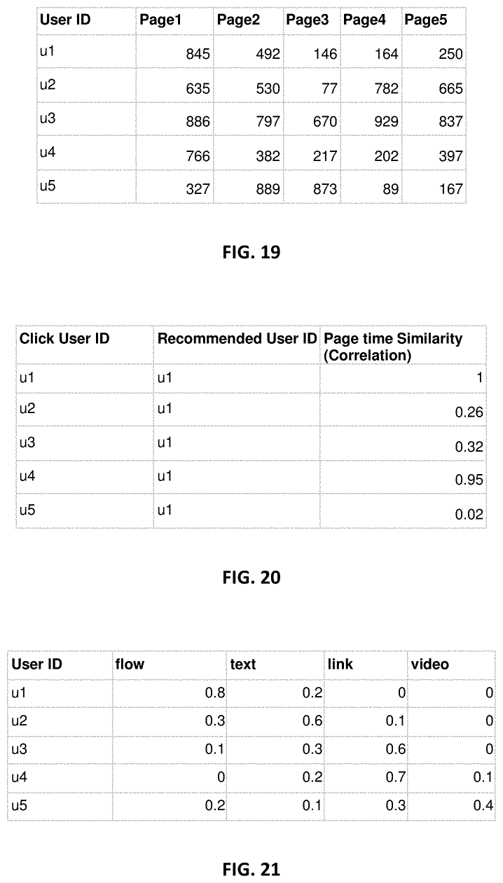

Referring to FIGS. 19-32, after a Repeat Usage analysis such as that described above is performed, the exemplary approach proceeds to a Similar Users analysis. In some embodiments, a Similar Users analysis measures the similarity of users by using different behavior dimensions and then recommends content that other similar users are using. In the exemplary Similar Users analysis described below, six different behavior dimensions are used. In other embodiments, additional or fewer behavior dimensions may be utilized. For each behavior dimension, a user behavior matrix may be created (see FIG. 19 for example), with row indexes representing the user ids and columns representing parameters of the dimension. Data may be looked at for past n days (n being a hyperparameter). Using each of these matrixes, a user similarity can be calculated between all pairs of users for each of the behavior dimensions being utilized. The similarities may be calculated based upon different distance metrics (which can act as hyperparameters), such as:
Correlation
Euclidean Distance
Manhattan Distance
Minkowski Distance
Hamming Distance
Cosine Similarity

Once all of the similarities are calculated from the various behavior dimensions, one or more having the best output(s) may be selected in order to recommend content to a user based on content used by similar users.

Referring now to FIG. 19, a first behavior matrix is shown, based on the dimension of page time similarity. To create the matrix, the top k pages used in the underlying application (where k is a hyperparameter) are considered, and the amount of time each user has spent only on these pages is determined. From these numbers, a page time similarity for each pair of users may be calculated, as shown in FIG. 20.

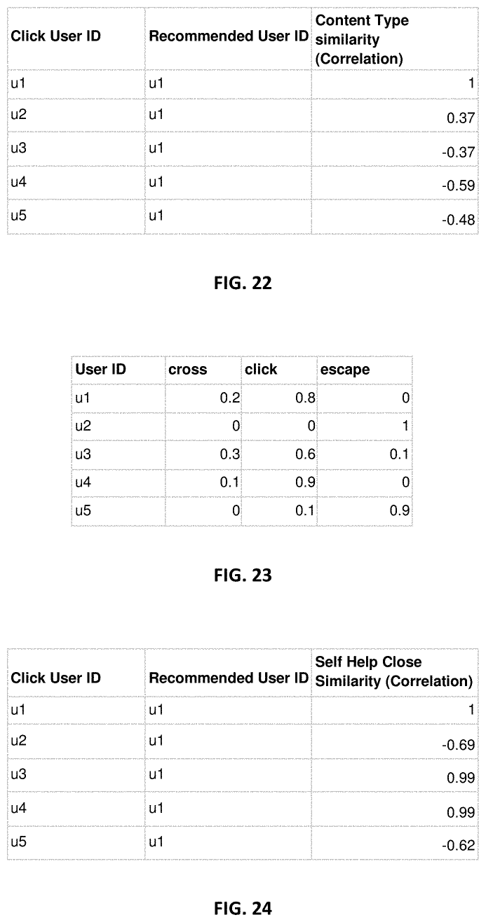

Referring now to FIG. 21, a second behavior matrix is shown, based on the dimension of content type usage. To create this matrix, the proportion of each type of content (e.g., flow, text, link, video, etc.) used by a user is considered as the dimension of the user behavior vector and the similarity between users may be calculated based upon it. From these numbers, a single content type usage similarity may be calculated for each pair of users, as shown in FIG. 22.

Referring now to FIG. 23, a third behavior matrix is shown, based on the dimension of what path a user takes to close the digital adoption program/self-help widget. In some embodiments, the digital adoption program may be closed by either clicking on a cross or X button, by clicking somewhere outside of the program/widget, or by pressing the escape button. Using the cross method suggests the user pays attention to the user interface of the program/widget. Clicking somewhere outside of the program suggests general usage. Pressing the escape button suggests the user is tech savvy. The proportion of each of the ways a user closes the self-help program provides the dimensions of this behavior matrix. The similarity between users based upon this dimension may be calculated from these numbers, as shown in FIG. 24.

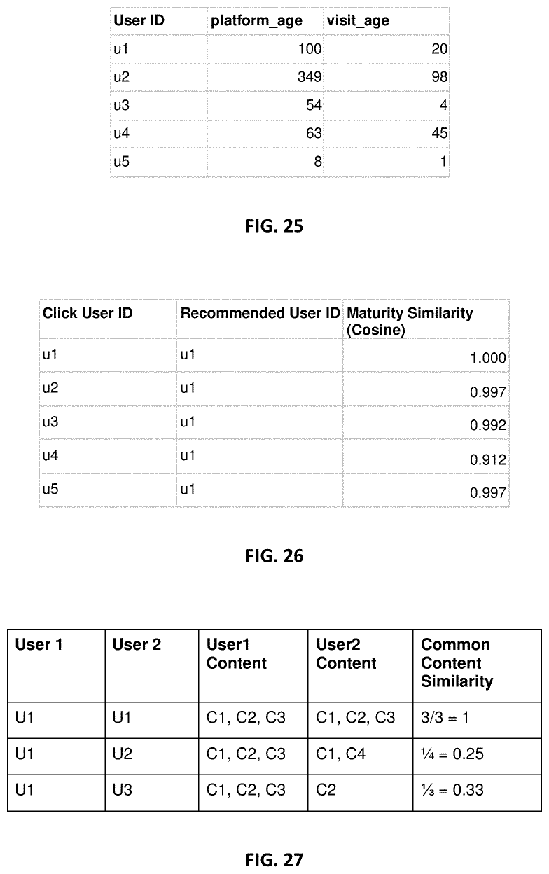

Referring now to FIG. 25, a fourth behavior matrix is shown. This matrix is based on the dimension of user maturity. Maturity or experience of users can also play a big role in how similarly they look at an underlying application. In this exemplary embodiment, there are two types of ages that were defined for this similarity measure. The first is platform age, which refers to the number of days since the user was onboarded to the platform. The second is visit age, which refers to the number of days on which the user has made a visit to the application. FIG. 25 provides hypothetical example numbers for both types of age, and FIG. 26 illustrates a calculation summary of Maturity Similarity between users based upon the numbers in FIG. 25.

Referring now to FIG. 27, a fifth behavior matrix is shown. This matrix is based on the dimension of common content usage, and measures the proportion of common contents consumed by users. This directly provides user similarity. The first and second columns of the table indicate the users that are being compared in each row, the third and fourth columns provide hypothetical examples of content consumed by each of the two users being compared, and the fifth column provides a calculation of common content similarity between each pair of users. In the fifth column calculations, the numerator is the number of common Contents used between the users, and the denominator is the number of distinct Contents used between the users.

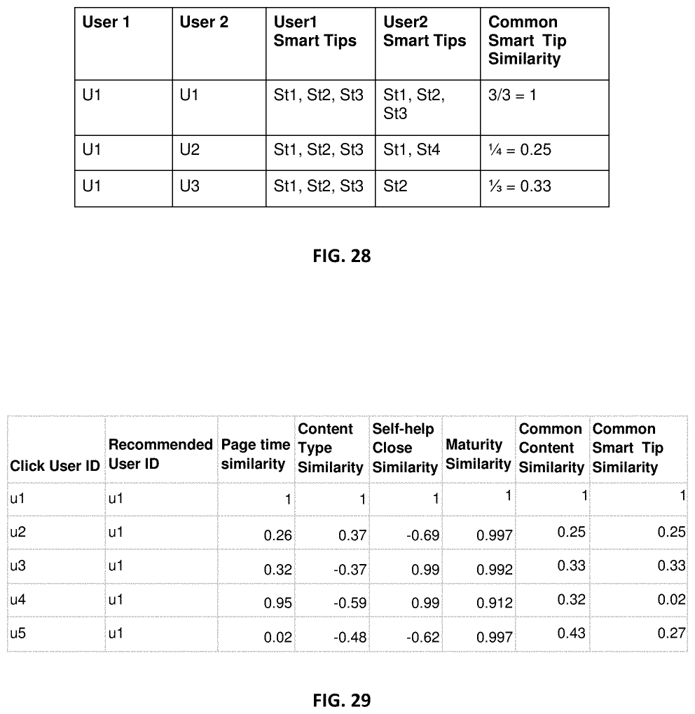

Referring now to FIG. 28, a sixth behavior matrix is shown. This matrix is based on the dimension of common Smart Tips usage, and measures the proportion of common Smart Tips used by pairs of users. Smart Tips are help contents that appear for a user while they are interacting with a particular element of the underlying application. Users who are executing the same task on the underlying application would encounter the same smart tips. So, the proportion of common smart tips encountered by the user is another similarity metric on its own. This metric also directly provides user similarity. The first and second columns of the table indicate the users that are being compared in each row, the third and fourth columns provide hypothetical examples of Smart Tips used by each of the two users being compared, and the fifth column provides a calculation of common Smart Tip similarity between each pair of users. In the fifth column calculations, the numerator is the number of common Smart Tips used between the users, and the denominator is the number of distinct Smart Tips used between the users.

Referring now to FIG. 29, the similarity results from the above six different behavior dimensions are combined. In some embodiments, all the users who have consumed at least 1 piece of content in the decided n days are considered for “click users” (shown in column 1), while the users for whom contents are being recommended are termed “recommendation users” (shown in column 2). For each combination of users in FIG. 29, a weighted average method among all the dimensions of similarity may be used to evaluate final similarity. The weights assigned are also a hyperparameter. The following formula can be used:

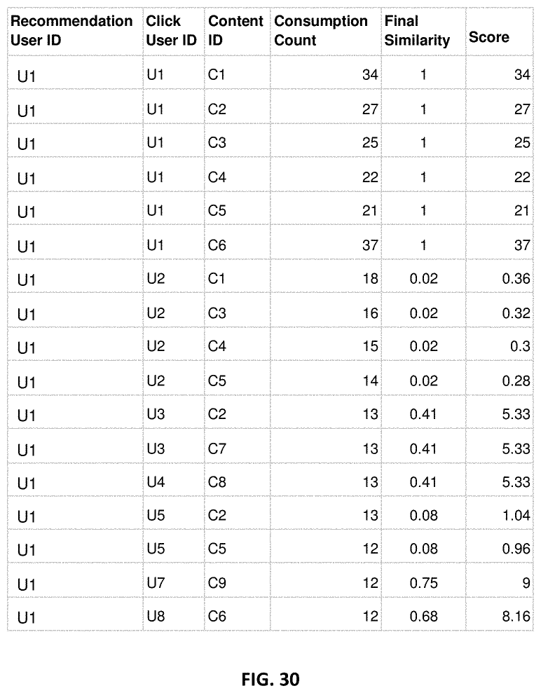

Final Similarity=sum(wi*similarity(i)),

where wi is a weight assigned to each dimension i. p Referring now to FIG. 30, final similarity numbers calculated from FIG. 29 (shown in column 5 of FIG. 30) are used to calculate scores (column 6) for Content IDs (column 3). In order to come up with recommendations for a user, (u1 in this example), the similarity of click users with u1 (column 5) and the number of times a content was consumed by the click users (column 4) can be considered. The number of click users most similar to u1 may be chosen to proceed with the calculations. This number of most similar click users is also a hyperparameter. The Score in column 6 may be calculated by multiplying the Consumption Count and Final Similarity.

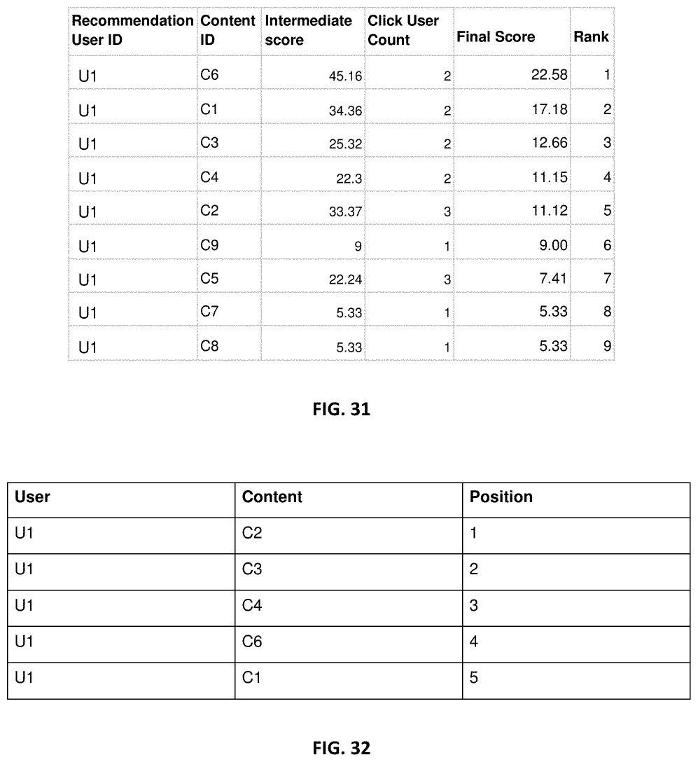

Referring now to FIG. 31, an Intermediate Score (shown in column 3) may be calculated by summing up the scores for each Content ID in FIG. 30. For example, Content ID c7 appears only once in FIG. 30, so its score of 5.33 is used as the Intermediate Score in row 8 of FIG. 31. Content ID c1 appears twice in FIG. 30, so its scores of 34 and 0.36 are summed to obtain the Intermediate Score of 34.36 in row 2 of FIG. 31. Next, the number of users who clicked on a piece of content are summed in column 4 of FIG. 31. For example, Content ID c7 appears once in column 3 of FIG. 30 so it has a Click User Count of 1 in row 8 of FIG. 31, Content ID c1 appears twice in column 3 of FIG. 30 so it has a Click User Count of 2 in row 2 of FIG. 31, and Content ID c2 appears three times in column 3 of FIG. 30 so it has a Click User Count of 3in row 5 of FIG. 31. Next, a Final Score (column 5) of each Content ID can be obtained for every user by dividing the Intermediate Score (column 3) by the Click User Count (column 4). The Ranking order (column 6) may then be obtained by sorting the rows by their Final Score, in descending order, as shown in FIG. 31. In this hypothetical example, Content ID c6 ranks number 1, and Content ID c1 ranks number 2. As these Content IDs have not already been proposed for recommending to user U1 by previous approaches, they take Positions 4 and 5, respectively, as shown in FIG. 32.

### Popular Analysis

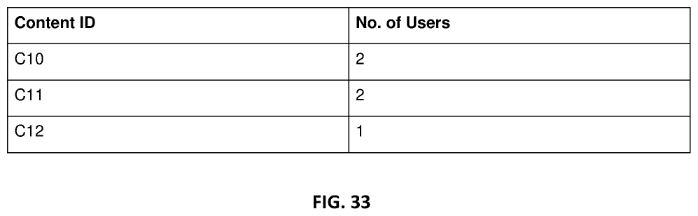

Referring now to FIG. 33, after a Similar Users analysis such as that described above is performed, the exemplary approach may proceed to a Popular Content analysis. In this step, if sufficient recommendations for a user were not able to be identified using the above four approaches, then content used by other users of the underlying application (e.g., C10, C11 and/or C12, in that order) may be used to fill any remaining spots of the recommendation list.

In some embodiments, if a user does not interact with any content after viewing the content recommendations personalized for them, they would see a fresh set of contents the next time they visit self-help. This may be done with the help of a rejected content list maintained at the user level. A piece of content may be added to the rejected list only if the user opened self-help and did not consume any content from the recommended content.

The overall approaches described above look at various, multiple facets of a user's behavior. Feedback capture can help developers of the self-help contents decide whether certain recommended contents should be refreshed.

Recommendations for a given user can be different for different pages of the underlying application, making the contents more relevant to a given page. The above methodologies also take care of users who have very general requirements through popular and repeat approaches.

In some embodiments, fewer or additional steps to those described herein may be utilized, and/or the steps may be performed in a different order.

Various alternatives, modifications, and equivalents may be used in lieu of the above components. Additionally, the techniques described here may be implemented in hardware or software, or a combination of the two. The techniques may be implemented in computer programs executing on programmable computers that each includes a processor, a storage medium readable by the processor (including volatile and nonvolatile memory and/or storage elements), and suitable input and output devices. Program code may be applied to data entered using an input device to perform the functions described and to generate output information. The output information may be applied to one or more output devices.

Each program may be implemented in a high-level procedural or object-oriented programming language to operate in conjunction with a computer system. However, the programs may be implemented in assembly or machine language, if desired. In any case, the language may be a compiled or interpreted language.

Each such computer program can be stored on a storage medium or device (e.g., CD-ROM, hard disk or magnetic diskette) that is readable by a general or special purpose programmable computer for configuring and operating the computer when the storage medium or device is read by the computer to perform the procedures described. The system also may be implemented as a computer-readable storage medium, configured with a computer program, where the storage medium so configured causes a computer to operate in a specific and predefined manner.

Thus, any of the methods (including user interfaces) described herein may be implemented as software, hardware or firmware, and may be described as a non-transitory computer-readable storage medium storing a set of instructions capable of being executed by a processor (e.g., computer, tablet, smartphone, etc.), that when executed by the processor causes the processor to control or perform any of the steps, including but not limited to: displaying, communicating with the user, analyzing, modifying parameters (including timing, frequency, intensity, etc.), determining, alerting, or the like.

While exemplary embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure. Numerous different combinations of embodiments described herein are possible, and such combinations are considered part of the present disclosure. In addition, all features discussed in connection with any one embodiment herein can be readily adapted for use in other embodiments herein. It is intended that the following claims define the scope of the invention and that methods and structures within the scope of these claims and their equivalents be covered thereby.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached, or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the disclosure. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present disclosure.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

In general, any of the apparatuses and/or methods described herein should be understood to be inclusive, but all or a sub-set of the components and/or steps may alternatively be exclusive, and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims. When a feature is described as optional, that does not necessarily mean that other features not described as optional are required.

The examples and illustrations included herein show, by way of illustration and not of limitation, specific embodiments in which the subject matter may be practiced. As mentioned, other embodiments may be utilized and derived therefrom, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method of personalizing digital guidance for use in an underlying computer application, the method comprising the steps of:
identifying an underlying application in which it is desired to provide personalized guidance content recommendations;
gathering usage data of the underlying application at a user level for n days;
choosing at least two methods from the group consisting of sequence analysis, top popular analysis, repeat usage analysis, similar users analysis and popular analysis,
wherein the sequence analysis comprises identifying guidance contents that have a high probability of being used one after other,
wherein the top popular analysis comprises identifying guidance content that is used by more than a threshold proportion of users in a predetermined period of time,
wherein the repeat usage analysis comprises calculating an affinity of users to reuse content frequently and an affinity of content used by users repeatedly,
wherein the similar users analysis comprises measuring a degree of similarity between a plurality of click users and a recommendation user, and then recommending content being used by click users who have a high degree of similarity to the recommendation user, and
wherein the popular analysis comprises identifying content used frequently by other users of the underlying application;
combining results from the at least two chosen methods; and
recommending content to the recommendation user based upon the combined results.

2. The method of claim 1, wherein the step of choosing at least two methods from the group comprises choosing at least three methods from the group.

3. The method of claim 1, wherein the step of choosing at least two methods from the group comprises choosing at least four methods from the group.

4. The method of claim 1, wherein the step of choosing at least two methods from the group comprises choosing all five methods from the group.

5. The method of claim 1, wherein the step of combining results from the at least two methods from the group comprises ruling out a high ranking content recommendation produced by one of the methods and selecting a lower ranking content recommendation from the one method if the high ranking content has already been produced by another of the methods.

6. The method of claim 1, wherein the step of choosing at least two methods from the group comprises choosing the similar users analysis, and the similar users analysis comprises creating at least one user behavior matrix from the gathered data.

7. The method of claim 6, wherein the similar users analysis comprises creating a plurality of user behavior matrices from the gathered data.

8. The method of claim 7, wherein at least one of the plurality of user behavior matrices comprises a first axis representing users of the underlying application and a second axis representing different pages of the underlying application.

9. The method of claim 8, wherein values in the at least one matrix represent a predetermined measure of each of the users' behavior on the different pages.

10. The method of claim 9, further comprising using the behavior matrix to perform a user similarity calculation for each pair of the users to obtain a similarity number for each of the pairs of users.

11. The method of claim 10, further comprising tabulating a consumption count for each of the users and a particular piece of digital guidance content each user has consumed, each of the consumption counts reflecting a number of times a particular user has consumed the particular content.

12. The method of claim 11, further comprising using the user similarity numbers and the consumption counts to perform a series of score calculations for the recommendation user, wherein each of the score calculations is a product of one of the consumption counts and an associated one of the similarity numbers.

13. The method of claim 12, further comprising calculating an intermediate score for each of the pieces of content from the tabulating step, wherein each of the intermediate scores is calculated by summing the series of score calculations for each of the pieces of content.

14. The method of claim 13, further comprising counting a number of users who clicked on each of the pieces of content to obtain a click user count for each piece of content.

15. The method of claim 14, further comprising obtaining a final score for each of the pieces of content by dividing its intermediate score by its click user count.

16. The method of claim 15, further comprising deciding on a ranking order of the content for the recommendation user based on the final scores placed in descending order.

17. The method of claim 16, further comprising selecting at least a highest ranked piece of content from the ranking step and using this highest ranked piece of content in the step of combining results from the at least two chosen methods.

18. The method of claim 10, wherein the user similarity calculations are based on one or more distance metrics selected from a group consisting of Correlation, Euclidean Distance, Manhattan Distance, Minkowski Distance, Hamming Distance and Cosine Similarity.

19. The method of claim 7, wherein each of the plurality of user behavior matrices is based on a different behavioral dimension.

20. The method of claim 19, wherein each of the different behavioral dimensions is selected from the group consisting of page time similarity, content type usage, path taken to close self-help, user maturity, common content usage, and common smart tips usage.

21. The method of claim 20, wherein the plurality of user behavior matrices comprises at least six user behavior matrices.

22. The method of claim 21, wherein all six of the behavioral dimensions of the group are utilized.

23. A method of personalizing digital guidance for use in an underlying computer application, the method comprising the steps of:
identifying an underlying application in which it is desired to provide personalized guidance content recommendations;
gathering usage data of the underlying application at a user level for n days;
choosing at least one method from the group consisting of sequence analysis, top popular analysis, repeat usage analysis and popular analysis,
wherein the sequence analysis comprises identifying guidance contents that have a high probability of being used one after other,
wherein the top popular analysis comprises identifying guidance content that is used by more than a threshold proportion of users in a predetermined period of time,
wherein the repeat usage analysis comprises calculating an affinity of users to reuse content frequently and an affinity of content used by users repeatedly, and
wherein the popular analysis comprises identifying content used frequently by other users of the underlying application;
combining and/or finalizing results from the at least one chosen method; and
recommending content to the recommendation user based upon the combined and/or finalized results.
